(19) United States
(12) Patent Application Publication
(10) Pub. No.: US 2005/0080955 A1
(43) Pub. Date: Apr. 14, 2005

(54) Very high dynamic range interface for connecting peripheral devices to a computer

(75) Inventors: Pavel Ionov, Glendale, CA (US); Monica Kaas Bar-Sever, Altadena, CA (US); Scott Cooper Jordan, San Jose, CA (US)

Correspondence Address: SMALL PLANET PHOTONICS, 4790 IRVINE BOULEVARD, SUITE 104, IRVINE, CA, 92620, US

(73) Assignee: Small Planet Photonics, Irvine, CA (US)

(21) Appl. No.: 10/948,825

(22) Filed: Sep. 23, 2004

Related U.S. Application Data
(60) Provisional application No. 60/506,439, filed on Sep. 26, 2003.

(51) Int. Cl. G06F 13/12

(52) U.S. Cl. 710/62

(57) ABSTRACT

A new very high dynamic range interface for connecting peripheral devices to a computer is disclosed. The interface comprises a normalized analog value signal and a range signal that could be analog or digital. The interface described by the present invention has improved dynamic range, accuracy, bandwidth and latency in comparison to the interfaces commonly used in the art.

### CROSS-REFERENCE TO RELATED APPLICATIONS

This application claims the benefit of U.S. Provisional Application No. 60/506,439 filed Sep. 26, 2003

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to the problem of connecting a peripheral device to a computer. More particularly, this invention is useful when the peripheral device is used to quantify a physical quantity and the measure of the quantity being quantified varies by many orders of magnitude.

It is often encountered in scanning and other applications that a fast optical or other sensor signal that varies by many orders of magnitude has to be transmitted to a computer without a significant delay. A diagram of the typical apparatus used in the art is shown in FIG. 1. A peripheral measuring device 110, measures a physical value or a plurality of physical values 102 of a physical system 101. The peripheral device 110 is further connected to a computer 130 by means of an interface 120. As is accepted in the art, the interface 120 is understood to comprise a transmission medium such as electrical wires or optical fibers or electromagnetic waves in free space, or any combination of the above. The interface further comprises the rules of interpreting the signals carried by the chosen medium as information.

In a typical scanning application, the computer 130 modifies the control 132 and records the information it receives from the peripheral measuring device 110 by means of the interface 120. In an open loop application, the control 132 is changed independently and the data is recorded by the computer as a function of the control. Examples of such applications are spectroscopy, laser microscopy and surface profilometry, to name a few.

In a closed loop application, the computer 130 receives the information from the peripheral device 110 about the physical system 101. The computer 130 further processes the information by a control algorithm and changes the control 132 to achieve a predefined goal about the physical system 101. Examples of such application are automated alignment and automated tracking. While the present invention is particularly useful in such open and closed loop scanning and control applications, it could also be useful in other applications, including applications where the control 132 is not used, or where the computer and the peripheral device are a part of a larger system.

For the best performance, both open and closed loop applications require wide analog bandwidth and low latency of the entire loop, which includes peripheral measuring device 110, interface 120, computer 130 and the control 132. When the physical value 102 changes rapidly or by many orders of magnitude, as is often the case in these applications, the interface 120 becomes performance limiting of the whole apparatus. The methods and apparatus existing in the art for implementing the interface 120 suffer from different drawbacks and are chosen on the basis of which problem dominates.

One such interface used in the art is presented schematically in FIG. 2. The peripheral device 210 comprises a transducer 211 for converting the physical value 202 into raw electrical signal 212 and a fixed gain amplifier 213. The interface 220 comprises an analog signal 221 that is proportional to the physical value 202. The analog signal is measured with an on-board data acquisition (DAQ) card 231 (or analog to digital converter if it is an imbedded system) of the computer 230. By knowing the gain of the amplifier and responsivity of the transducer 211, the computer 230 could compute the absolute physical value 202. The gain of the amplifier is carefully chosen. To avoid clipping, the gain is chosen such that the maximum of the analog signal 220 does not exceed the maximum of the DAQ 231 range. Further to maintain accuracy, the gain is chosen such that the maximum of the analog signal 220 is not significantly lower than the maximum of the DAQ 231 range.

At the present time, typical resolution of data acquisition cards and analog-to-digital converters (ADC) is 16 bit (or 65,536 step) or less, with higher resolution achieved at a sacrifice to speed and stability and at an increased price. This significantly limits the dynamic range of the apparatus. If 0.1% measurement accuracy is required and at least a factor of two safety margin against clipping is allowed for large signals, this leaves factor of 65,536/2/1000≈33 dynamic range available. This is insufficient for many applications, and if this approach is used, measurement accuracy dramatically decreases at lower signal levels.

Another analog interface alternative known in the art is diagrammed in the FIG. 3. In this embodiment of a single signal analog interface, the raw electrical signal 312 is compressed by means of a logarithmic amplifier 313. The interface 320, thus, comprises one analog signal 321 per physical value 302 being measured. The value of the analog signal 321 is approximately proportional to the logarithm of the physical value 302. This approach offers improved dynamic range, but suffers from significantly reduced accuracy and asymmetric time response. The inaccuracy is due to the compressed nature of the signal representation, increased sensitivity to offset drift and due to the inaccuracy in producing the true logarithm of the signal.

A third alternative is a digital interface. One such prior art embodiment is shown schematically in the FIG. 4. In this embodiment, the raw electrical signal 402 is sent to automatic gain control (AGC) circuitry 413. The AGC circuitry comprises a variable gain amplifier with optional signal conditioning (filtering for instance) 414 and a micro-controller 417. The micro-controller 417 could be a single or multiple chip circuit that comprises at least one analog-to-digital converter and programmable logic circuitry. The micro-controller 417 analyses the output 415 of the variable gain amplifier 414 and a gain control signal 416 to either increase or decrease the gain. Thus, the output 415 could be always normalized to fall within a predefined range of values. From the value of the normalized signal 415 and the gain set by the gain control signal 416, the micro-controller 417 calculates the value of the raw signal 412 and the physical value 402. Further, the micro-controller 417 sends the calculated value to the computer 430 though any of the common digital interfaces 420 known in the art.

All of the common digital interfaces used in the art have significant drawbacks for this application. Serial interfaces, such as RS-232 or USB, are most commonly used to reduce the number of lines required and to increase the maximum allowed cable length as compared to a parallel interface. Unfortunately, such interfaces have a limited bandwidth and a high and inconsistent latency. An alternative is a network connection, such as Ethernet that have become very prevalent. However, networks have even larger and even more inconsistent latencies and often a more limited bandwidth, particularly if many computers are connected. The delays are particularly dramatic if the computer 430 that collects the data runs a multitasking operating system, which is the typical case for these types of applications. While the parallel digital interface could be faster, it is inconvenient because of requirement to transmit many signals and is unreliable at longer cable length. Furthermore, a parallel digital interface would not help with the delays arising due to multitasking operating system.

Thus, at the present time there is no satisfactory interface for transmitting information about a value that varies by many orders of magnitude from a peripheral device to a computer.

### BRIEF SUMMARY OF THE INVENTION

The subject matter of the invention is better understood in reference to the FIG. 5. The invention comprises a novel interface 520 that is useful in transferring information from a peripheral device 510 about a value, such as physical value 502 or raw analog value 512, to a computer 530. The interface 520 comprises an analog normalized value signal 521, a range signal 522. The normalized value signal 521 is maintained within a narrow range of values by varying the gain between the raw signal 512 and the normalized signal 521. The range signal 522 caries the information about the gain setting and optional status information to the computer 530. Further, the range signal 522 could be analog, or digital. The computer uses the normalized value signal 521 and the range signal 522 to calculate the transmitted value. In one embodiment, the interface 520 could also comprise an enable signal 523.

### BRIEF DESCRIPTION OF THE SEVERAL VIEWS OF THE DRAWINGS

FIG. 1. A diagram of the apparatus used in the art for which the interface described by the present invention is useful.

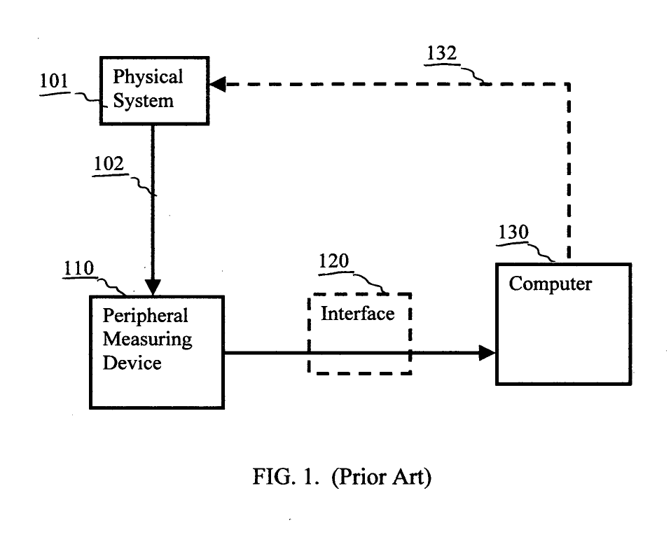

FIG. 2. A diagram of the apparatus used in the art for wide dynamic range signals that utilizes a fixed gain amplifier and single analog signal interface.

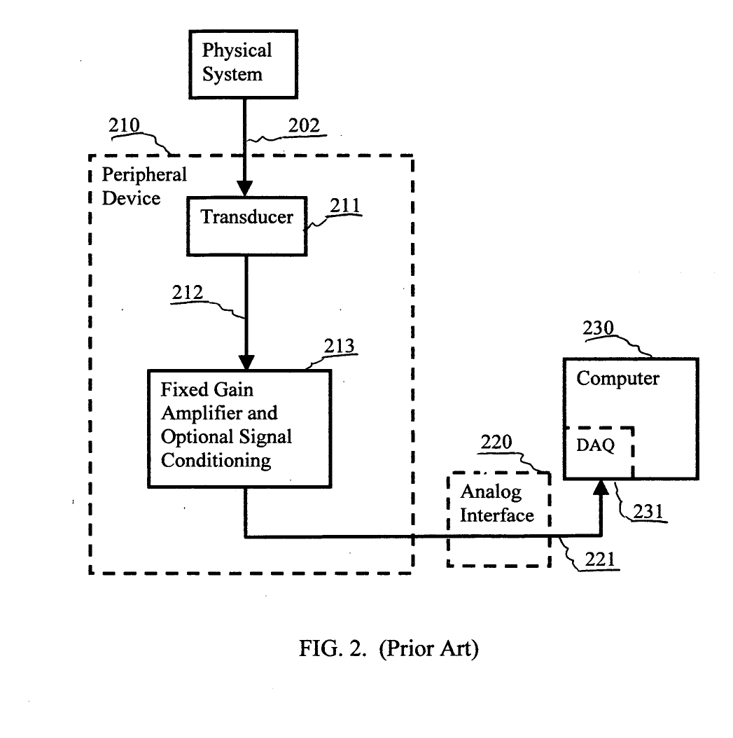

FIG. 3. A diagram of the apparatus used in the art for wide dynamic range signals that utilizes an interface comprising a single analog logarithmic signal.

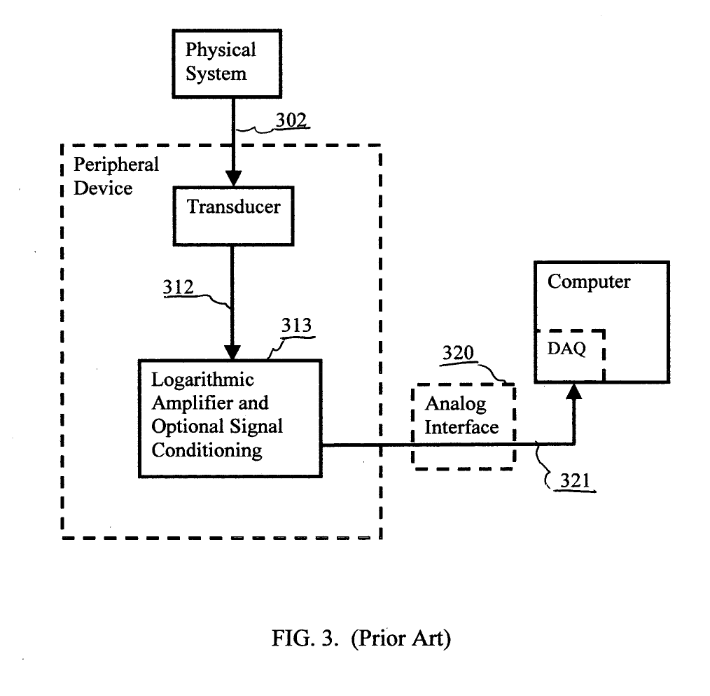

FIG. 4. A diagram of the apparatus used in the art for wide dynamic range signals that utilizes an automatic gain control (AGC) and a digital interface.

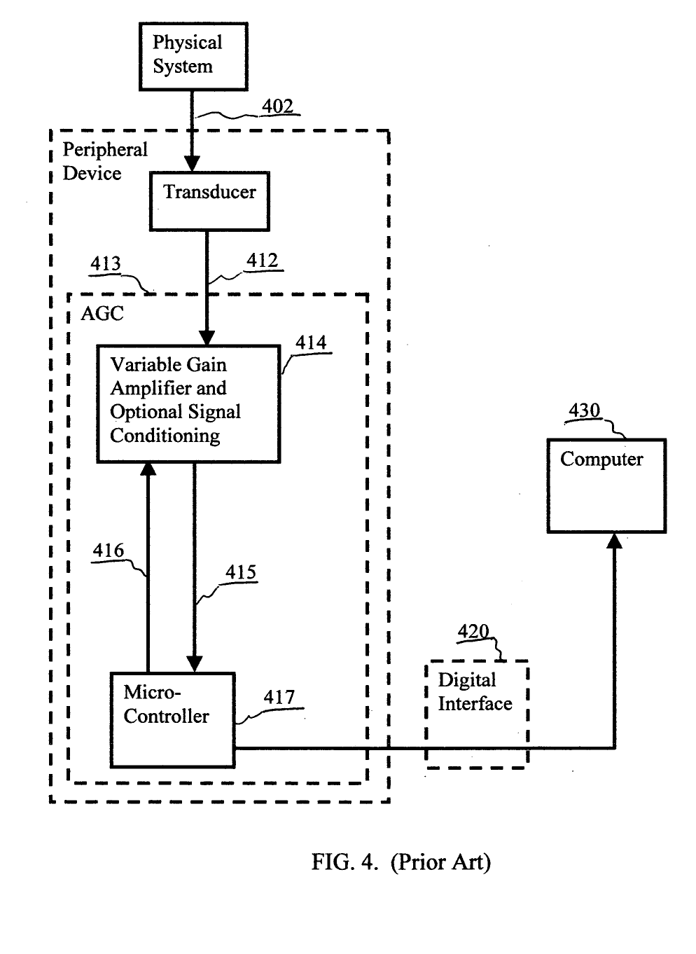

FIG. 5. A diagram of one embodiment of the apparatus of the present invention.

### DETAILED DESCRIPTION OF THE INVENTION

1211 The present invention comprises an interface for transferring information from a peripheral device to a computer about a value that varies by many orders of magnitude. The peripheral device could be a sensor or a measurement instrument that is used to convert a physical parameter into an analog electrical signal. The computer could be a personal computer, a mainframe computer, a handheld computing device, a programmable logic controller (PLC), a micro-controller (master or slave), or other programmable logic machine. The main benefits of the present invention are wide dynamic range, wide bandwidth and low latency.

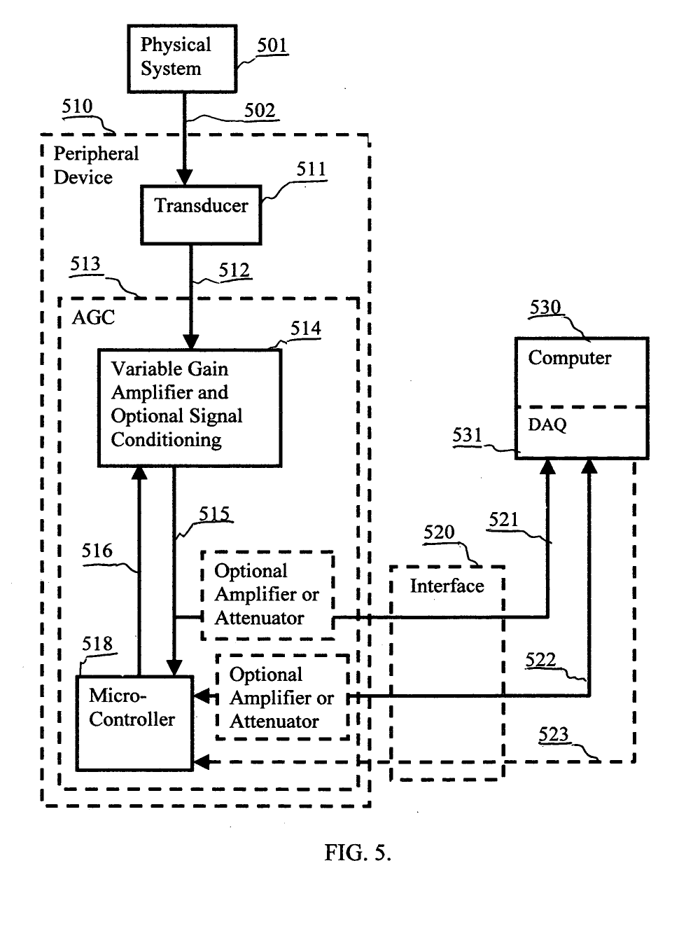

In reference to FIG. 5, the interface 520 that comprises the present invention is implemented as follows. The interface comprises an analog normalized value signal 521 and a range signal 522. The normalized value signal 521 is an analog signal, value of which is equal to a product of a gain that could be chosen from a small set of gains (as opposed to an infinite set of gains or a continuously varying gain) and the analog value being transmitted, such as the raw signal 512 or the physical value 502. In the embodiment where the physical value is transmitted, the physical value 502 is calculated from the raw signal value 512 and a responsivity calibration table for the transducer 511 as is known in the art. Further, the peripheral measuring device 510 amplifies or attenuates the raw signal 512 in such a manner that the value signal 521 is within a certain narrow range of values and the ratio of the value signal 521 and the value being transmitted (also referred to as gains herein) could be chosen from a small set of values. The range signal 522 carries the information about the selected gain from the allowed set of gains and optional status information to or from the computer 530. The computer uses the normalized value signal 521 and the range signal 522 to calculate the value being transmitted. Thus, the information transferred by the range signal 522 is substantially reduced. This allows increased bandwidth as compared to transferring information about the raw signal 512 value or the physical value 502 by means of a digital interface. At the same time because the normalized signal is kept in a narrow range of values, a higher accuracy and wider dynamic range are achieved as compared to transferring the information by means of a single analog interface.

In one specific embodiment, the gain between the value being transmitted is chosen from a small set of gains and the small set of gains comprises a geometrical progression, whereby each successive member is produced by multiplying the last member by a constant. Since a geometrical progression could be represented by a power of the multiplier, the range signal only needs to indicate the power. For instance, if the chosen progression is 2, 20, 200 and 2000 then the range signal only has to transmit 0, 1, 2, and 3. This requires only two bits in the binary representation to cover a range of three orders of magnitude.

One specific embodiment of the interface is further detailed in the FIG. 5. The embodiment comprises an unobvious enhancement to an automatic gain control (AGC) commonly used in the art. The raw signal 512 enters the AGC 513, and the AGC 513 outputs, not only a normalized signal 521 as is done in the art, but also a range signal 522 that carries information about the gain setting and optionally status information about the peripheral device 510. The ACG 513 of this embodiment comprises a variable gain amplifier 514 and micro-controller 518. The micro controller 518 analyses the output signal 515 of the variable gain amplifier 514 and produces a gain control signal 516 to the variable gain amplifier 514 using any algorithm commonly known in the art. In addition to this standard AGC function, the micro controller 518 sends the range signal 522 to the computer 530. The variable gain amplifier 514 and the micro-controller 518 comprise any of the single component or multiple component embodiments commonly known in the art. The micro-controller 518 further comprises at least one analog-to-digital converter and at least one programmable logic circuit.

The range signal 522 of the present invention could be analog or digital, further it could be single or multi-line. A multi-line signal is understood as being carried by a plurality of instances of the transmission medium, such as plurality of electrical wires or optical fibers. The digital embodiments of the range signal 522 could be parallel or serial. In one specific embodiment, the range signal 522 comprises the gain control signal 516.

In the embodiment comprising an analog range signal, the range signal 522 could assume a number of predefined levels to indicate the gain setting. For instance, if the set of gain settings of the variable gain amplifier 514 is 3, 9 and 30, then range signal level of 1 V could indicate gain of 3, level of 1.5 V could indicate gain of 9 and level of 2 V could indicate gain of 30. Furthermore, additional levels could indicate status. For instance, level of 0 V could indicate an uncertain state of the gain, such as during a transient.

In the embodiment comprising a parallel digital signal, the range signal 522 is transmitted in the usual parallel interface manner known in the art. However, in combination with the normalized value signal, the required number of parallel lines is substantially reduced. For instance, if the chosen set of gains is 0.15, 1.5, 15 and 150, the range signal could be transmitted over two parallel binary logic lines. If three orders of magnitude are not enough, the ratio of subsequent gains in the set could be increased or the number of parallel lines increased. For instance, with a geometrical progression of gains with a multiple of 10, three parallel binary lines would cover seven orders of magnitude of gain, and so on.

In the embodiment comprising a serial digital signal, the range signal 522 is transmitted in the usual serial interface manner known in the art. Since only a few bits of information have to be transmitted, the bandwidth and latency are significantly improved. For instance, if the chosen set of gains is 2, 16, 128 and 1024, the range signal could be transmitted with only two bits. Furthermore, the arrival of the first bit could indicate the start of the gain change of the variable gain amplifier 514. The computer 530 could take into account the known settling time of the amplifier 514, and for instance, discard the unreliable data that are received during such settling time.

In the preferred embodiment of the present invention, the peripheral device 510 comprises a sensor for quantifying a physical value 502 or a plurality of values. In the most preferred embodiment, the peripheral device 510 is an optical sensor. The preferred embodiment of the present invention comprises a transducer 511, a variable gain amplifier 514, a micro-controller 518 and the interface 520. Further, electrical wires comprise the transmission medium of the interface 520. The micro-controller 518 comprises logic programming circuitry as is known in the art, and at least one analog-to-digital converter and at least one digital-to-analog converter. The physical value 502 being quantified by the peripheral device 510 is converted into an analog electrical signal 512 by the transducer 511. The signal 512 is further amplified by the variable gain amplifier 514 that is controlled by the micro-controller 518 such that the normalized signal 515 is within a specific narrow range of values. This is accomplished by the micro-controller 518 evaluating the normalized signal 515 with an analog-to-digital converter. If the micro-controller 518 detects that the normalized signal 515 is outside of the predefined narrow range of values, the micro-controller 518 sends the gain control signal 516 to the variable gain amplifier 514 to change the gain to compensate. Further, the gain is set in such a manner that the ratio of value signal 521 and the value being transmitted is chosen from a small set of values. Simultaneously, the micro-controller 518 sends the range signal 522 to the computer 530 to indicate the gain change. In the preferred embodiment, the range signal 522 is analog and assumes a set of equally spaced values in voltage, such as 1 V, 2 V, 3 V, etc. Each value corresponds to an allowed value of the ratio of signal 521 to value being transmitted. Further, the set of ratio values comprises a geometrical progression. One or more values of the range signal 522 could be reserved to indicate the status of the peripheral device 510, such as “not ready”, or “changing gain”. In the preferred embodiment, the range signal 522 is produced by a digital-to-analog converter that the micro-controller 518 comprises and is optionally amplified with an amplifier. Further, the range signal 522 is evaluated by a data acquisition card onboard the computer 530 that is either the same or different DAQ from the DAQ 531 used to evaluate signal 521.

One specific embodiment of the present invention is particularly useful in apparatus employing synchronous detection, also known as lock-in detection, as is understood in the art. As is practiced in the art, during synchronous detection the physical value that is being quantified is modulated and the average of the difference of measurements during off and on periods is taken as the measure of the physical value. In such application it may be useful to enable AGC 513 during some part of the modulation cycle and disable it during the rest of the cycle keeping the gain constant. For instance, the AGC 513 could be on when the physical value is on and off when the physical value is off. In this embodiment of the invention, the interface also comprises an enable signal 523 that enables or disables the gain control function of the AGC 513. In another specific embodiment, AGC 513 could have the ability to be optionally disabled by the software of the micro-controller 518, or by any other means of communicating a disable command to the peripheral device 510.

It may be beneficial in some applications to take other considerations besides the value of the normalized value signal 521 in setting the gain of the variable gain amplifier 514 onboard the peripheral device 510. For instance, it may be desirable to account for information from other peripheral devices also connected to the computer 530 or general information about the system 501 that is known before the measurement in determining the level and exact timing of the gain control signal 516. One specific embodiment of this invention addresses this need for this more complex decision making in setting the gain. As opposite to some of the previously described embodiments where the range signal 522 is sent from the peripheral devise 510 to the computer 530, in this embodiment the range signal 522 is sent from the computer 530 to the peripheral devise 510 to command the gain control signal 516 directly or through the micro-controller 518. The range signal 522 could also be optionally amplified/attenuated onboard of the peripheral device 510 with an optional amplifier/attenuator. This embodiment allows maintaining the value signal 521 within the desired range of values by computer 530 commanding the peripheral device 510 to increase or decrease the gain if the value signal 521 approaches a limit of the desirable range of values. Thus, a very wide dynamic range, wide bandwidth and low latency are achieved. In addition, other information or considerations could be taken into account in setting the gain.

Having described several embodiments of the present invention, many other equivalent or alternative embodiments could become apparent to those of skill in the art. The alternatives and equivalents are intended to be included within the scope of the present invention.

1. A very high dynamic range interface for transferring information from a peripheral device to a computer comprising:
an analog normalized value signal; and,
a range signal.

2. The method of claim 1, wherein said peripheral device amplifies or attenuates the raw signal by a gain chosen from a small set of gains to obtain said analog normalized value signal in such a manner that said value signal is within a certain narrow range of values.

3. The method of claim 2, wherein said range carries the information about said gain.

4. The method of claim 2, wherein said small set of gains comprises a geometrical progression.

5. The method of claim 2, wherein said range signal assumes a number of predefined levels comprising levels to indicate said gain.

6. The method of claim 5, wherein said levels comprise at least one level to indicate said peripheral device status.

7. The method of claim 1, wherein said peripheral device comprises an automatic gain control.

8. The method of claim 7, wherein said automatic gain control comprises:
at least one variable gain amplifier; and,
at least one micro-controller.

9. The method of claim 7, wherein said range signal comprises gain control signal of said automatic gain control.

10. The method of claim 1, wherein said range signal is an analog signal.

11. The method of claim 1, wherein said range signal is a digital signal.

12. The method of claim 11, wherein said range signal is a parallel digital signal.

13. The method of claim 11, wherein said range signal is a serial digital signal.

14. The method of claim 1, wherein said range signal is a single line signal.

15. The method of claim 1, wherein said range signal is a multi-line signal.

16. The method of claim 1, wherein said peripheral device comprises a sensor.

17. The method of claim 16, wherein said sensor is an optical sensor.

18. The method of claim 16, wherein said peripheral device further comprises:
at least one transducer;
at least one variable gain amplifier; and,
at least one micro-controller.

19. The method of claim 1, wherein electrical wires comprise the transmission medium of the said very high dynamic range interface.

20. The method of claim 1, wherein said very high dynamic range interface further comprises an enable signal.

21. The method of claim 1, wherein said range signal is sent from peripheral device to the said computer.

22. The method of claim 1, wherein said range signal is sent from computer to said peripheral device.
